(19) United States
(12) Patent Application Publication
(10) Pub. No.: US 2025/0390226 A1
(43) Pub. Date: Dec. 25, 2025

(54) SINGLE-LEVEL CELL CACHING NOTIFICATION

(71) Applicant: Micron Technology, Inc., Boise, ID (US)

(72) Inventors: Kyle J. Wilkins, Meridian, ID (US); Steven Wells, Sacramento, CA (US); Cory M. Steinmetz, Boise, ID (US)

(21) Appl. No.: 19/242,196

(22) Filed: Jun. 18, 2025

Related U.S. Application Data
(60) Provisional application No. 63/661,673, filed on Jun. 19, 2024.

(51) Int. Cl. G06F 3/06

(52) U.S. Cl. CPC G06F 3/0613; G06F 3/0646; G06F 3/0673

(57) ABSTRACT

The present disclosure configures a system component, such as a memory sub-system controller, to provide notifications to a host system based on an single-level cell (SLC) storage tier. The controller stores data in a storage tier associated with a first type of storage. The controller determines an amount of space remaining in the storage tier for storing additional data and transmits a message to a host system representing the amount of space remaining in the storage tier for storing the additional data.

### PRIORITY APPLICATION

This application claims the benefit of priority to U.S. Provisional Application Ser. No. 63/661,673, filed Jun. 19, 2024, which is incorporated herein by reference in its entirety.

### TECHNICAL FIELD

Examples of the disclosure relate generally to memory sub-systems and, more specifically, to providing SMART logs to a host system.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment including a memory sub-system, in accordance with some examples.

FIG. 2 is a block diagram of an example media operations manager, in accordance with some examples.

FIGS. 3-4 are flow diagrams of example methods to perform media management operations, in accordance with some examples.

FIG. 5 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

The present disclosure configures a system component, such as a memory sub-system controller, to provide notifications to a host system informing the host system about a current amount of storage space remaining in an SLC storage tier or SLC storage (e.g., an SLC cache, SCL storage device, and/or SLC buffer). Specifically, the controller can transmit the notifications upon request by the host system or periodically. The notification can selectively include a field with information indicating whether the SLC storage device remaining space has fallen below a threshold amount (e.g., 5% of the size of the SLC storage device). The host system can throttle or delay sending one or more additional write requests to the memory sub-system in case the remaining space in the SLC storage device has fallen below the threshold amount. This can prevent overloading the memory controller and allow the memory controller time to transfer data from the SLC storage device to tri-level cell (TLC), MLC, or quad-level cell (QLC) storage tier or storage device in a set of memory components to free up space in the SLC storage device. In this way, the overall efficiency of operating the memory sub-system is improved.

As referred to herein, the term “storage tier” means a hierarchical level of data storage within a memory sub-system that is associated with a specific type of storage technology, characterized by distinct performance, capacity, and cost attributes. Storage tiers are organized to optimize overall system performance by temporarily storing data in faster, more expensive storage before transferring it to slower, higher-capacity storage. In the context of solid-state drive (SSD) technology, storage tiers can include: a primary storage tier: SLC storage that serves as a fast, durable cache or buffer for temporarily storing incoming data before transfer to denser storage tiers; and a secondary storage tier; and a multi-level cell storage tier, such as Triple-Level Cell (TLC), Multi-Level Cell (MLC), or Quad-Level Cell (QLC) storage that provides greater capacity at lower cost but with reduced performance compared to SLC storage.

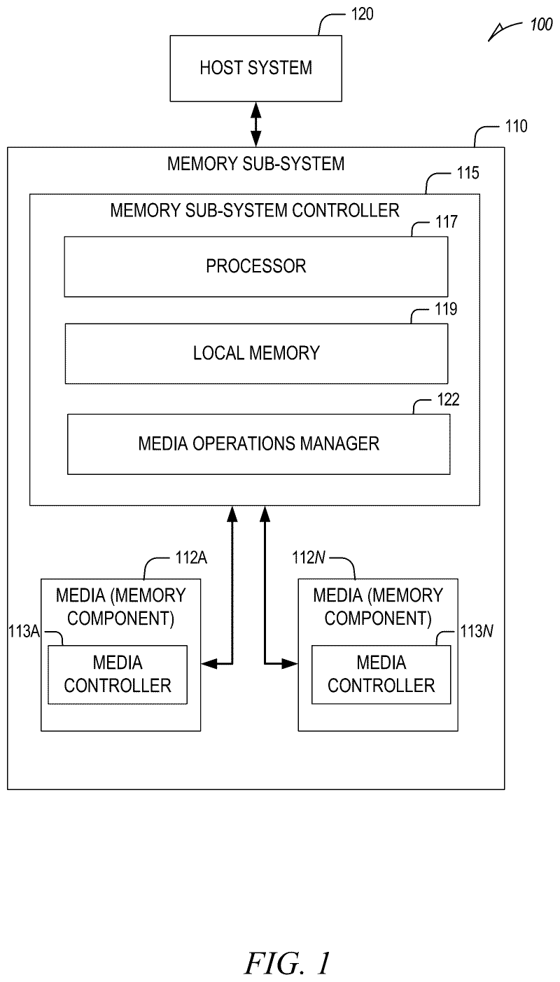

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data”.

The different memory components (e.g., memory blocks, sub-blocks, word lines, planes, memory dies, and so forth) can each store a respective read count value indicating the quantity or number of times the respective memory component has been read. This read count value can be compared against a read disturb condition criterion (e.g., a read count threshold) which can be used to control when read disturb scan operations are performed for the memory component. Read disturb scan operations involve reading data from one or more portions or specified word lines (WLs) of the memory component and determining whether a read bit error rate (RBER) of the read data transgresses a threshold. If so, the read disturb scan operations refresh or fold the data from the memory component to another memory component. If not, the read disturb scan operations continue monitoring and/or accessing a different memory component and/or memory block.

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data”. “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management (e.g., read disturb scan operations), different near miss error correction code (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package.

In the field of solid-state drive (SSD) technology, the integration of Single-Level Cell (SLC) storage tier and Triple-Level Cell (TLC) storage represents a significant advancement, designed to balance performance with cost efficiency. SLC storage device, which is fast and durable, temporarily stores incoming data before it is transferred to the denser, slower TLC storage that offers greater capacity at a lower cost. This tiered storage approach aims to enhance both the performance and lifespan of SSDs. However, this system encounters inefficiencies and potential resource waste, particularly when the host sends numerous write requests in a short period, leading to the saturation of the SLC storage device. When the SLC storage device fills up, any additional incoming data must be written directly to the slower TLC storage. This bypasses the SLC storage device's speed advantage, resulting in a significant decrease in overall write performance. Such conditions lead to slower system response times and reduced operational efficiency.

Moreover, frequent direct writes to TLC storage not only degrade performance but also increase wear and tear on the TLC cells, which are less durable than SLC cells. This increased wear can shorten the lifespan of the TLC storage, escalating maintenance costs and impacting the sustainability of the storage solution. The inefficiency in managing the data flow between the SLC storage device and TLC storage under high write load conditions leads to suboptimal utilization of the SSD's capabilities, manifesting as increased power consumption and reduced throughput. This results in higher operational costs and a larger carbon footprint. Additionally, managing the overflow from SLC to TLC under high load conditions requires complex firmware algorithms that handle data integrity and ensure no data loss occurs during high traffic periods. The complexity of these operations increases the computational overhead, further straining the resources of the SSD.

Given these challenges, the disclosed techniques provide an innovative solution that optimizes the data transfer between SLC storage device and TLC storage, particularly under conditions of high write intensity by informing a host system about the current space remaining in the SLC storage device. This can be used by the host system to ensure optimal utilization of both SLC and TLC components to improve performance, durability, and efficiency, thereby addressing the noted inefficiencies and resource wastage.

Specifically, the disclosed techniques provide a memory controller that can transmit notifications to a host system informing the host system about the current state of the SLC storage device. In some cases, these notifications are included as part of the Self-Monitoring, Analysis, and Reporting Technology (SMART) logs that are transmitted periodically or asynchronously (upon request by the host system). In some cases, other notifications (different from SMART logs) can be used to communicate the information to the host system about the current state of the SLC storage device. This way, minimal additional resources are needed to provide the notifications to the host system. The host system can then delay or throttle sending additional write requests to allow the memory controller sufficient idle time to flush the SLC storage device to TLC storage so that future write requests can be processed faster and more efficiently.

For some examples, the memory sub-system (e.g., memory sub-system controller) stores data in a storage tier associated with a first type of storage. The controller determines an amount of space remaining in the storage tier for storing additional data. The controller transmits a message to a host system representing the amount of space remaining in the storage tier for storing the additional data. The controller can transmit the message to the host system prior to transferring the data stored in the storage tier to the set of memory components associated with a second type of storage.

In some cases, the first type of storage includes single-level cell (SLC) storage. The second type of storage includes tri-level cell or triple-level cell (TLC) storage tier, MLC storage tier, and/or quad-level cell (QLC) storage. The controller can transfer the data stored in the storage tier to the set of memory components associated with the second type of storage and prevents processing write requests while transferring the data stored in the storage tier to the set of memory components associated with the second type of storage.

The controller can receive a request from the host system for health status of the memory sub-system. The controller, in response to receiving the request, transmits the message to the host system representing the amount of space remaining in the storage tier for storing the additional data. The message is transmitted as part of a (SMART) log. The controller can selectively add information (e.g., a byte in a field) to the SMART log representing the amount of space remaining in the storage tier (e.g., storage device, cache, and/or buffer).

The controller can compare the amount of space remaining in the storage tier to a threshold amount. The controller, in response to determining that the amount of space remaining in the storage tier fails to transgress the threshold amount, adds the information to the SMART log indicating that the amount of space remaining in the storage tier fails to transgress the threshold amount. In some examples, the controller compares the amount of space remaining in the storage tier to a threshold amount. The controller, in response to determining that the amount of space remaining in the storage tier transgresses the threshold amount, can exclude the information from the SMART log to indicate to the host system that the amount of space remaining in the storage tier transgresses the threshold amount.

In some cases, the controller generates a SMART log and periodically sends the SMART log to the host system. The SMART log can selectively include the message representing the amount of space remaining in the storage tier for storing the additional data. The controller can selectively add information to the SMART log representing the amount of space remaining in the storage tier. The controller can cause the host system to delay sending one or more write requests to the memory sub-system based on the message representing the amount of space remaining in the storage tier for storing the additional data. The host system can resume sending the one or more write requests in response to determining that the amount of space remaining in the storage tier transgresses a threshold amount. The threshold amount includes a five percent of an entire size of the storage tier. Any other suitable threshold can be used. The threshold can be specified by an operator, configuration data, or by the host system.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies).

In some examples, the first memory component 112A or group of memory components including the first memory component 112A can be associated with a first temperature threshold (or tolerance) and/or reliability (capability) grade, value or measure. Reliability grade, value or measure is used interchangeably throughout and can have the same meaning. Temperature threshold and temperature tolerance measure is used interchangeably throughout and can have the same meaning. The second memory component 112N or group of memory components including the second memory component 112N can be associated with a second temperature threshold and/or reliability (capability) grade, value or measure. In some examples, each memory component 112A to 112N can store respective configuration data that specifies the respective temperature threshold. In some examples, a memory or register can be associated with all of the memory components 112A to 112N which can store a table that maps different groups, bins or sets of the memory components 112A to 112N to respective temperature thresholds. In some examples, each of the memory components 112A to 112N can store a write temperature that has been measured when data was written to the respective memory component 112A to 112N. This data can be stored in a separate write temperature register of each memory component 112A to 112N and/or as part of the underlying data stored to the respective memory component 112A to 112N.

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The memory components 112A to 112N can include any combination of the different types of non-volatile memory components and/or volatile memory components. An example of non-volatile memory components includes NOR- and (NAND)-type flash memory. Each of the memory components 112A to 112N can include one or more arrays of memory cells such as single-level cells (SLCs) or multi-level cells (MLCs) (e.g., TLCs or QLCs). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory.

In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), (NOR) flash memory, electrically erasable programmable read-only memory (EEPROM), and a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages, WLs, planes, blocks, or sub-blocks that can refer to a unit of the memory component 112 used to store data. In general, the memory pages, WLs, sub-blocks, and/or blocks are collectively or individually referred to as memory components.

The memory sub-system controller 115 can communicate with the memory components 112A to 112N to perform operations such as reading data, writing data, or erasing data at the memory components 112A to 112N and other such operations. The memory sub-system controller 115 can communicate with the memory components 112A to 112N to perform various memory management operations, such as different scan rates, different scan frequencies, different wear leveling, different read disturb management operations, such as read disturb scan operations, different near miss ECC operations, folding operations, preventing folding operations from being performed, and/or different dynamic data refresh operations.

The memory sub-system controller 115 can include hardware such as one or more integrated circuits and/or discrete components, one or more thermometers (used to measure a current operating temperature of the memory sub-system 110 and/or the memory components 112A to 112N or ambient temperature), a buffer memory, and/or a combination thereof. In some examples, the output of the one or more thermometers can be used to determine a current write temperature to be stored in association with data on the memory components 112A to 112N.

The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another example, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112N to 112N.

The memory sub-system controller 115 can be responsible for other memory management operations, such as wear leveling operations, garbage collection operations, error detection and error-correcting code (ECC) operations, encryption operations, caching operations, media scans, data refreshing, read disturb operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

The memory sub-system controller 115 can communicate with the local memory 119 to store one or more write requests in an SLC storage device. The local memory 119 can include SLC storage which can be of a smaller size than TLC storage of the set of memory components 112A to 112N. In some cases, the memory sub-system controller 115 can initially store the write requests in the SLC storage device. Once the memory sub-system 110 is in an idle state or when one or more other conditions are met, the memory sub-system controller 115 can automatically transfer the data stored in the SLC storage of the local memory 119 to the TLC storage or QLC storage of the set of memory components 112A to 112N.

The memory sub-system controller 115 can receive additional requests to write data when the SLC storage device is full. In such cases, the memory sub-system controller 115 can directly write the data to the TLC storage of the set of memory components 112A to 112N. However, performing such operations take significantly longer than storing the data in the SLC storage device. As such, it may be beneficial to allow the host system 120 to wait for the SLC storage device to free up space before issuing additional write requests in order to have those requests stored in the SLC storage device instead of being directly written to the TLC storage.

The memory sub-system controller 115 can include a media operations manager 122. The media operations manager 122 can be configured to provide notifications to the host system 120 based on the SLC storage device. The media operations manager 122 stores data in the SLC storage device associated with a first type of storage (e.g., SLC storage). The media operations manager 122 determines an amount of space remaining in the storage tier for storing additional data and transmits a message to the host system 120 representing the amount of space remaining in the storage tier for storing the additional data. The host system 120 can then throttle sending additional requests to the memory sub-system 110 to ensure such requests are stored in the SLC storage device rather than being directly written to the TLC storage which improves the overall efficiency of operating the memory sub-system 110.

The media operations manager 122 can generate and send various SMART logs to the host system 120. The notifications about the state of the SLC storage device can be provided in the SMART logs. The SMART logs can be used to monitor the health of the SSD at regular intervals during device power on of the memory sub-system 110 or other points in time. There can be a standard list of device health metrics that SSD's track over its life cycle. There is also an ability with SMART metrics that the host system 120 can request the SSD to report if certain events happen. These are called Asynchronous Event Requests (AER). If a certain event happens, the SSD can send a high importance notification to the host in the SMART log.

The media operations manager 122 can add a byte to the SMART log to that tracks how much SLC storage device the SSD (e.g., the memory sub-system 110) has remaining. The byte can be added to a reserved area of the SMART log. Namely, the SMART log can include multiple types of thermal management temperature transition counts that contain the number of times the controller transitioned to lower power active power states or performed vendor specific thermal management actions. The SMART log can include a total time for thermal management temperatures that contain the number of seconds that the controller had transitioned to lower power active power states or performed vendor specific thermal management actions. The SMART log can include memory sub-system 110 sub-system reliability indicating whether reliability has been compromised due to significant media errors, an internal error, the media being placed in read only mode, or a volatile memory backup device failing. The SMART log can include a temperature threshold field indicating that the temperature is greater than or equal to an over temperature threshold or less than or equal to an under temperature threshold. The SMART log can include a spare below threshold field indicating whether the available space capacity of the memory sub-system 110 has fallen below a threshold. The SMART log can include one or more reserved byte fields.

Depending on the examples, the media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein. Further details with regards to the operations of the media operations manager 122 are described below.

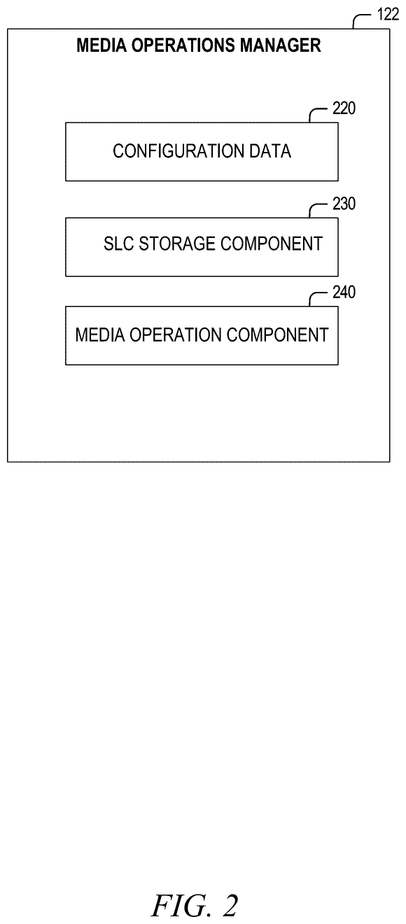

FIG. 2 is a block diagram of an example media operations manager 122, in accordance with some examples. As illustrated, the media operations manager 200 includes configuration data 220, an SLC storage device component 230, and a media operation component 240. For some examples, the media operations manager 122 can differ in components or arrangement (e.g., less or fewer components) from what is illustrated in FIG. 2.

The configuration data 220 accesses and/or stores configuration data associated with the memory components 112A to 112N. In some examples, the configuration data 220 is programmed into the media operations manager 122. For example, the media operations manager 122 can communicate with the memory components 112A to 112N to obtain the configuration data and store the configuration data 220 locally on the media operations manager 122. In some examples, the media operations manager 122 communicates with the host system 120. The host system 120 receives input from an operator or user that specifies parameters including a threshold amount of space remaining in the SLC storage device (e.g., five percent of the total size of the SLC storage device). The threshold amount of space remaining can control whether the host system 120 is notified, such as using the SMART log, about the space remaining in the SLC storage device. The media operations manager 122 receives the configuration data from the host system 120 and stores the configuration data in the configuration data 220.

The SLC storage device component 230 can include some or all of the components of the local memory 119. The SLC storage device component 230 can implement SLC storage for temporarily storing data associated with write requests received from the host system 120. During an idle state of the memory sub-system 110 and/or when one or more conditions are met (e.g., the amount of data stored in the SLC storage device reaches a specified threshold amount), the media operation component 240 can transfer data from the SLC storage device component 230 to TLC/QLC storage of the set of memory components 112A to 112N. In some cases, while the data is being transferred from the SLC storage device component 230 to the TLC/QLC storage, the media operation component 240 can delay processing further write commands or requests to program data to the SLC storage device.

In some examples, the media operation component 240 can selectively include a field in a SMART log that notifies the host system 120 about the remaining capacity or remaining space available in the SLC storage device component 230. Specifically, the media operation component 240 can periodically determine how much space remains for additional data to be stored in the SLC storage device of the SLC storage device component 230. The media operation component 240 can compare that amount of space remaining to a threshold amount stored in the configuration data 220. For example, the threshold amount can include five percent of the total size of the SLC storage device. The media operation component 240 can determine whether the amount of space remaining fails to transgress the threshold amount (e.g., whether the amount of space remaining in the SLC storage device is less than five percent of the total size of the SLC storage device). If so, the media operation component 240 can generate or store a field in the reserved portion of the SMART log to notify the host system 120 about the remaining space in the SLC storage device.

For example, the media operation component 240 can store a value in the reserved portion of the SMART log indicating how much space remains available in the SLC storage device for additional write requests. In some cases, the media operation component 240 can store a binary value indicating that the amount of space remaining in the SLC storage device has fallen below a specified threshold amount (e.g., without specifying the specific amount of space remaining). The media operation component 240 can send the SMART log automatically and periodically to the host system 120 with or without the field in the reserved portion representing the amount of space remaining in the SLC storage device. In some cases, the media operation component 240 can send the SMART log to the host system 120 in response to receiving a request from the host system 120 for a health report associated with the memory sub-system 110. The media operation component 240 can, in response, provide the SMART log to the host system 120 with or without the field in the reserved portion representing the amount of space remaining in the SLC storage device. In some cases, the media operation component 240 can receive a specific request from the host system 120 for the amount of space remaining in the SLC storage device. In such cases, the media operation component 240 can compute how much space remains in the SLC storage device. The media operation component 240 can provide a notification or message to the host system 120 indicting the amount of space remaining or indicating whether or not the amount of space remaining is greater than or less than a threshold amount.

The media operation component 240 can only include the information representing the state or amount of remaining space available in the SLC storage device in the SMART log if the amount of space falls below the threshold amount. If the amount of space falls below the threshold amount, the media operation component 240 can add the information indicating the amount of space remaining or indicating that the amount of space remaining falls below the threshold in the SMART log. The media operation component 240 can then send the SMART log with that information to the host system 120. If the amount of space does not fall below the threshold amount, the media operation component 240 can exclude the information indicating the amount of space remaining or indicating that the amount of space remaining falls below the threshold from the SMART log. This can reduce the amount of resources needed to accomplish a task and improves the overall efficiency of operating the memory sub-system 110. The host system 120 can then determine whether or not to throttle or prevent sending additional requests to program data to the memory sub-system 110. For example, the host system 120 can periodically query the memory sub-system 110 for the space remaining in the SLC storage device. Once the memory sub-system 110 provides a notification, such as a SMART log, indicating that the SLC storage device includes available space that is greater than the threshold amount, the host system 120 can resume sending additional requests to write data. This can ensure that the requests to program data are routed through the SLC storage device and are not directly written to the TLC storage which improves the overall efficiencies of operating the memory sub-system 110.

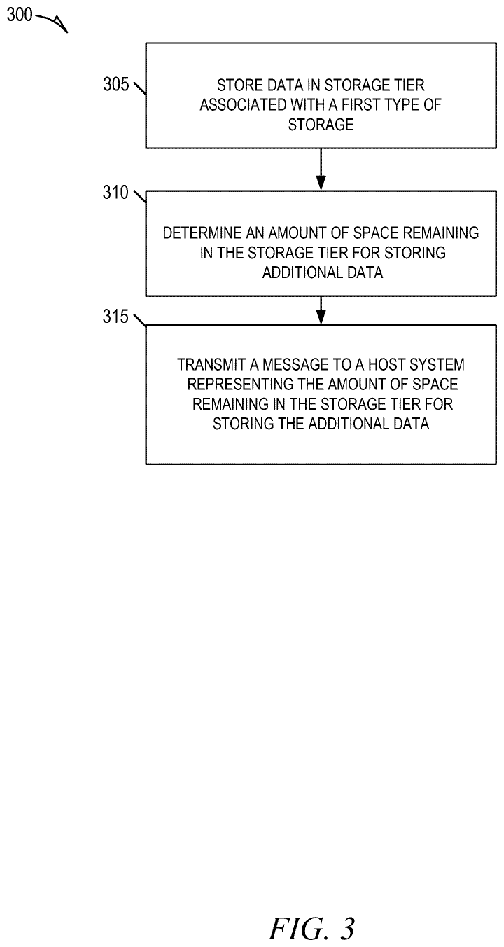

FIG. 3 is a flow diagram of an example method 300 to perform media management operations, in accordance with some examples. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 300 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 3, the method (or process) 300 begins at operation 305, with a media operations manager 122 of a memory sub-system 110 storing data in a storage tier associated with a first type of storage. At operation 310, the media operations manager 122 of the memory sub-system 110 determines an amount of space remaining in the storage tier for storing additional data. Thereafter, at operation 315, the media operations manager 122 transmits a message to a host system representing the amount of space remaining in the storage tier for storing the additional data.

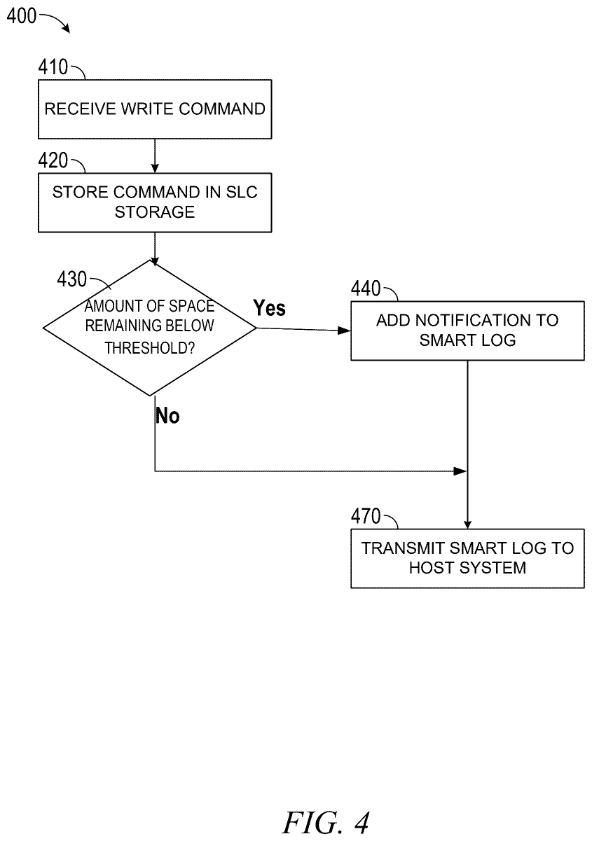

FIG. 4 is a flow diagram of an example method 400 to perform media management operations, in accordance with some examples. The method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 400 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 4, the method (or process) 400 begins at operation 410 where the media operations manager 122 (e.g., the firmware of the memory sub-system 110) receives one or more write commands from the host system 120. In response, the media operations manager 122 stores the one or more commands in the SLC storage storage tier at operation 420. Then, at operation 430, the media operations manager 122 determines whether the amount of space transgresses a threshold amount (e.g., whether the amount of space remaining is more or less than five percent of the total available capacity of the SLC storage device). In response to determining that the amount of space transgresses the threshold amount at operation 430, the media operations manager 122 performs operation 470 where a SMART log is sent to the host system 120 (e.g., automatically periodically and/or in response to a specific asynchronous request from the host system 120).

If the amount of space fails to transgress the threshold amount at operation 430 (e.g., if the amount of space remaining is less than five percent of the total amount of space in the SLC storage device), the media operations manager 122 performs operation 440 where a notification including information is added to the SMART log representing the amount of space remaining in the SLC storage device. The notification can be binary indicating whether or not there is additional space remaining in the SLC storage device or can be a value indicating the specific amount of space that remains in the SLC storage device. Using this information, the host system 120 can throttle or prevent sending additional write requests to the memory sub-system 110.

In view of the disclosure above, various examples are set forth below. It should be noted that one or more features of an example, taken in isolation or combination, should be considered within the disclosure of this application.

Example 1. A system comprising: a set of memory components of a memory sub-system; and a processing device operatively coupled to the set of memory components, the processing device being configured to perform operations comprising: storing data in a storage tier associated with a first type of storage; determining an amount of space remaining in the storage tier for storing additional data; and transmitting a message to a host system representing the amount of space remaining in the storage tier for storing the additional data.

Example 2. The system of Example 1, the operations comprising: transmitting the message to the host system prior to transferring the data stored in the storage tier to the set of memory components associated with a second type of storage.

Example 3. The system of Example 2, wherein the first type of storage comprises single-level cell (SLC) storage.

Example 4. The system of Example 3, wherein the second type of storage comprises tri-level cell (TLC) storage or quad-level cell (QLC) storage.

Example 5. The system of any one of Examples 2-4, the operations comprising: transferring the data stored in the storage tier to the set of memory components associated with the second type of storage; and preventing processing write requests while transferring the data stored in the storage tier to the set of memory components associated with the second type of storage.

Example 6. The system of any one of Examples 1-5, the operations comprising: receiving a request from the host system for health status of the memory sub-system; and in response to receiving the request, transmitting the message to the host system representing the amount of space remaining in the storage tier for storing the additional data.

Example 7. The system of Example 6, wherein the message is transmitted as part of a Self-Monitoring, Analysis, and Reporting Technology (SMART) log.

Example 8. The system of Example 7, the operations comprising: selectively adding information to the SMART log representing the amount of space remaining in the storage tier.

Example 9. The system of Example 8, the operations comprising: comparing the amount of space remaining in the storage tier to a threshold amount; and in response to determining that the amount of space remaining in the storage tier fails to transgress the threshold amount, adding the information to the SMART log indicating that the amount of space remaining in the storage tier fails to transgress the threshold amount.

Example 10. The system of any one of Examples 8-9, the operations comprising: comparing the amount of space remaining in the storage tier to a threshold amount; and in response to determining that the amount of space remaining in the storage tier transgresses the threshold amount, excluding the information from the SMART log to indicate to the host system that the amount of space remaining in the storage tier transgresses the threshold amount.

Example 11. The system of any one of Examples 1-10, the operations comprising: generating a Self-Monitoring, Analysis, and Reporting Technology (SMART) log; and periodically sending the SMART log to the host system, the SMART log selectively comprising the message representing the amount of space remaining in the storage tier for storing the additional data.

Example 12. The system of Example 11, the operations comprising: selectively adding information to the SMART log representing the amount of space remaining in the storage tier.

Example 13. The system of any one of Examples 1-12, the operations comprising: causing the host system to delay sending one or more write requests to the memory sub-system based on the message representing the amount of space remaining in the storage tier for storing the additional data.

Example 14. The system of Example 13, wherein the host system resumes sending the one or more write requests in response to determining that the amount of space remaining in the storage tier transgresses a threshold amount.

Example 15. The system of Example 14, wherein the threshold amount comprises a five percent of an entire size of the storage tier.

Methods and computer-readable storage medium with instructions for performing any one of the above Examples.

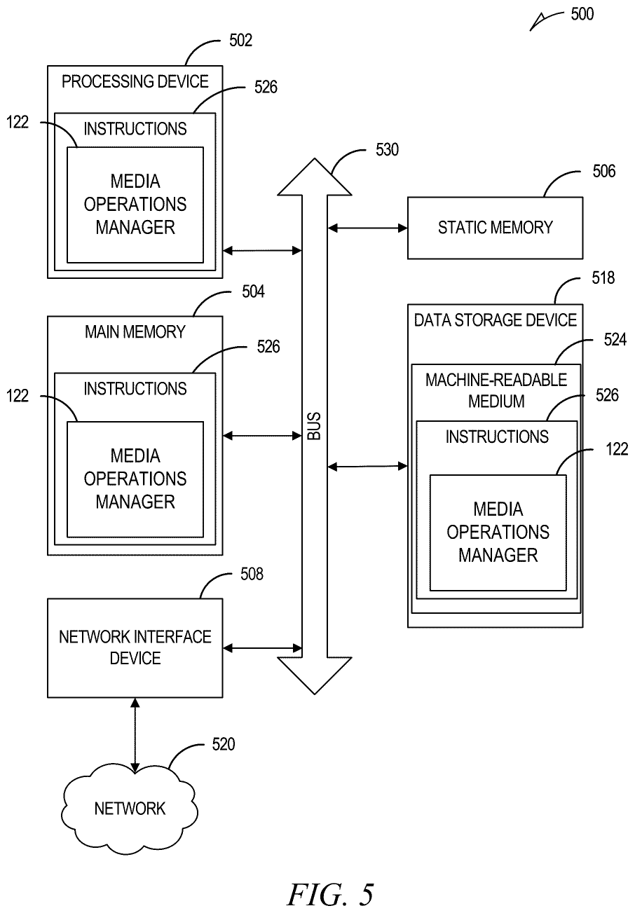

FIG. 5 illustrates an example machine in the form of a computer system 500 within which a set of instructions can be executed for causing the machine to perform any one or more of the methodologies discussed herein. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

The processing device 502 represents one or more general-purpose processing devices such as a microprocessor, a central processing unit, or the like. More particularly, the processing device 502 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 502 can also be one or more special-purpose processing devices such as an application specific integrated circuit (ASIC), a field programmable gate array (FPGA), a digital signal processor (DSP), a network processor, or the like. The processing device 502 is configured to execute instructions 526 for performing the operations and steps discussed herein. The computer system 500 can further include a network interface device 508 to communicate over a network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one example, the instructions 526 implement functionality corresponding to the media operations manager 122 of FIG. 1. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMs); erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, examples of the disclosure have been described with reference to specific example embodiments thereof. It will be evident that various modifications can be made thereto without departing from the broader examples of the disclosure as set forth in the following claims. The specification and drawings are, accordingly, to be regarded in an illustrative sense rather than a restrictive sense.

What is claimed is:

1. A system comprising:
a set of memory components of a memory sub-system; and
a processing device operatively coupled to the set of memory components, the processing device being configured to perform operations comprising:
storing data in a storage tier associated with a first type of storage;
determining an amount of space remaining in the storage tier for storing additional data; and
transmitting a message to a host system representing the amount of space remaining in the storage tier for storing the additional data.

2. The system of claim 1, the operations comprising:
transmitting the message to the host system prior to transferring the data stored in the storage tier to the set of memory components associated with a second type of storage.

3. The system of claim 2, wherein the first type of storage comprises single-level cell (SLC) storage.

4. The system of claim 3, wherein the second type of storage comprises tri-level cell (TLC) storage or quad-level cell (QLC) storage.

5. The system of claim 2, the operations comprising:
transferring the data stored in the storage tier to the set of memory components associated with the second type of storage; and
preventing processing write requests while transferring the data stored in the storage tier to the set of memory components associated with the second type of storage.

6. The system of claim 1, the operations comprising:
receiving a request from the host system for health status of the memory sub-system; and
in response to receiving the request, transmitting the message to the host system representing the amount of space remaining in the storage tier for storing the additional data.

7. The system of claim 6, wherein the message is transmitted as part of a Self-Monitoring, Analysis, and Reporting Technology (SMART) log.

8. The system of claim 7, the operations comprising:
selectively adding information to the SMART log representing the amount of space remaining in the storage tier.

9. The system of claim 8, the operations comprising:
comparing the amount of space remaining in the storage tier to a threshold amount; and
in response to determining that the amount of space remaining in the storage tier fails to transgress the threshold amount, adding the information to the SMART log indicating that the amount of space remaining in the storage tier fails to transgress the threshold amount.

10. The system of claim 8, the operations comprising:
comparing the amount of space remaining in the storage tier to a threshold amount; and
in response to determining that the amount of space remaining in the storage tier transgresses the threshold amount, excluding the information from the SMART log to indicate to the host system that the amount of space remaining in the storage tier transgresses the threshold amount.

11. The system of claim 1, the operations comprising:
generating a Self-Monitoring, Analysis, and Reporting Technology (SMART) log; and
periodically sending the SMART log to the host system, the SMART log selectively comprising the message representing the amount of space remaining in the storage tier for storing the additional data.

12. The system of claim 11, the operations comprising:
selectively adding information to the SMART log representing the amount of space remaining in the storage tier.

13. The system of claim 1, the operations comprising:
causing the host system to delay sending one or more write requests to the memory sub-system based on the message representing the amount of space remaining in the storage tier for storing the additional data.

14. The system of claim 13, wherein the host system resumes sending the one or more write requests in response to determining that the amount of space remaining in the storage tier transgresses a threshold amount.

15. The system of claim 14, wherein the threshold amount comprises a five percent of an entire size of the storage tier.

16. A method comprising:
storing data in a storage tier associated with a first type of storage;
determining an amount of space remaining in the storage tier for storing additional data; and
transmitting a message to a host system representing the amount of space remaining in the storage tier for storing the additional data.

17. The method of claim 16, comprising:
transmitting the message to the host system prior to transferring the data stored in the storage tier to a set of memory components associated with a second type of storage.

18. The method of claim 17, wherein the first type of storage comprises single-level cell (SLC) storage.

19. The method of claim 18, wherein the second type of storage comprises at least one of tri-level cell (TLC) storage, multi-level cell (MLC) storage, or quad-level cell (QLC) storage.

20. A non-transitory computer-readable storage medium comprising instructions that, when executed by a processing device, cause the processing device to perform operations comprising:
storing data in a storage tier associated with a first type of storage;
determining an amount of space remaining in the storage tier for storing additional data; and
transmitting a message to a host system representing the amount of space remaining in the storage tier for storing the additional data.
